(19) United States
(12) Patent Application Publication
(10) Pub. No.: US 2007/0008691 A1
(43) Pub. Date: Jan. 11, 2007

(54) Portable computer

(75) Inventor: Sung-yun Kim, Daejeon-city (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/480,501

(22) Filed: Jul. 5, 2006

(30) Foreign Application Priority Data
Jul. 6, 2005 (KR) 2005-60765

(51) Int. Cl. G06F 1/16

(52) U.S. Cl. 361/683

(57) ABSTRACT

A portable computer which has a computer main body, includes a common mounting part which is provided on the computer main body and selectively accommodates one of a plurality of external devices, each of which has an external device connector on a position different with another external device; and a plurality of mounting connectors which is provided in the common mounting part and disposed on a different position each other corresponding to the external device connector and connected with the external device connector of one of the plurality of the external devices mounted in the common mounting part. Thus, the portable computer allows a user to mount an external device in a common mounting part easily without checking a position of a connector.

### CROSS-REFERENCE TO RELATED APPLICATION

This application claims the benefit of Korean Patent Application No. 2005-60765, filed on Jul. 6, 2005 in the Korean Intellectual Property Office, the disclosure of which is incorporated herein by reference.

### BACKGROUND OF THE INVENTION

1. Field of the Invention

Aspects of the present invention relate to a portable computer, and more particularly, to a portable computer having a common mounting part which selectively mounts one of a plurality of external devices therein.

2. Description of the Related Art

More recent portable computers achieve a slim design by exchanging hardware that was internally mounted in an existing portable computer into an external type. Particularly, in the portable computer, various ports which are connected with a peripheral device are being removed to make the portable computer slim. However, the absence of the various ports lowers extension capability and causes inconvenience.

In order to tackle the foregoing problems, Korean Patent First Publication No. 2005-0005362 discloses a port replicator which comprises a plurality of ports. The replicator having the plurality of ports is connected with a supporting member, which is combined to a rear side of a notebook computer, through a connection cable. To expand the function of the conventional notebook computer, an additionally provided replicator is connected with the notebook computer through the supporting member and the connection cable. Also, the conventional notebook computer requires wide space as it is connected with the various devices, as well as the plurality of devices such as the supporting member, the connection cable and the replicator, thereby failing to provide a slim external appearance due to the plurality of devices.

Generally, the portable computer is detachably coupled with a drive device. For example, Korean Patent First Application No. 2003-0016738 discloses a portable computer which has a drive accommodator to accommodate a drive device therein.

### SUMMARY OF THE INVENTION

Accordingly, it is an aspect of the present invention to provide a portable computer in which a user mounts an external device in a common mounting part easily without checking a position of a connector.

Additional aspects and/or advantages of the present invention will be set forth in part in the description which follows and, in part, will be obvious from the description, or may be learned by practice of the present invention.

The foregoing and/or other aspects of the present invention are also achieved by providing a portable computer which has a computer main body, comprising a common mounting part which is provided on the computer main body and selectively accommodates one of a plurality of external devices each of which has an external device connector on a position different with another external device; and a plurality of mounting connectors which is provided in the common mounting part and disposed on a different position each other corresponding to the external device connector and connected with the external device connector of one of the plurality of the external devices mounted in the common mounting part.

According to another aspect of the present invention, the plurality of mounting connectors is provided in a transverse direction of an insertion direction of the external device.

According to another aspect of the present invention, the external device comprises an extension card having at least one port and a drive device, and wherein the plurality of mounting connectors comprises an extension card mounting connector which is provided in a main board of the computer main body and connected with the extension card, and a drive device mounting connector which is spaced from the extension card mounting connector and connected with the drive device.

According to another aspect of the present invention, the external device connector comprises an extension card connector which is provided in the extension card and connected with the extension card mounting connector, and a drive device connector which is provided in the drive device and connected with the drive device mounting connector.

According to another aspect of the present invention, the drive device comprises one of an optical disk drive and a hard disk drive.

The foregoing and/or other aspects of the present invention are also achieved by providing a portable computer which has a computer main body, comprising a common mounting part which is provided in the computer main body and accommodates an external device therein; a first external device which is selectively mounted in the common mounting part and comprises a first connector; a second external device which is selectively mounted in the common mounting part and comprises a second connector; and a first mounting connector and a second mounting connector which are connected with the first connector and the second connector, respectively, and provided in the common mounting part.

According to another aspect of the present invention, the first and second mounting connectors are provided in a transverse direction of an insertion direction of the first and second external devices.

According to another aspect of the present invention, the first external device comprises a drive device, and the second external device comprises an extension card which has at least one port.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view of a portable computer according to an embodiment of the present invention;

FIG. 2 illustrates the portable computer according to the embodiment of the present invention shown in FIG. 1 while mounting a CD-ROM drive therein;

FIG. 3 illustrates the portable computer according to the embodiment of the present invention shown in FIG. 1 while mounting a hard disk drive therein;

FIG. 4 illustrates the portable computer according to the embodiment of the present invention shown in FIG. 1 while mounting an extension card therein; and

FIG. 5 illustrates a portable computer according to an embodiment of the present invention while mounting an extension card therein.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Hereinafter, an external device comprises a drive device and an extension card as an exemplary embodiment of the present invention but not limited thereto. Alternatively, the external device according to the present invention may comprise any device which is detachably attached to a portable computer.

The drive device according to an aspect of the present invention comprises a hard disk drive (HDD) and/or an optical disk drive (ODD). The optical disk drive may comprise a CD-ROM drive, a CD-RW drive, a DVD drive, and or other optical drives, such as those used for HD-DVD and Blu-Ray drives. Hereinafter, the CD-ROM drive 60 will be described as an example of the optical disk drive according to the present invention.

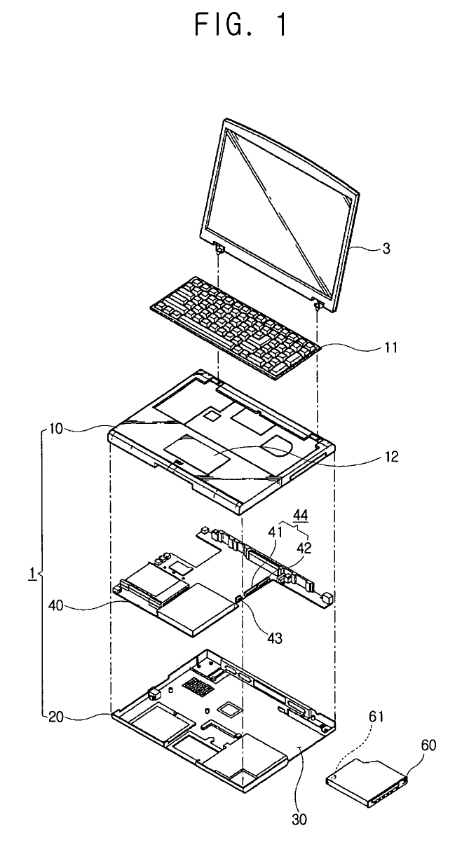

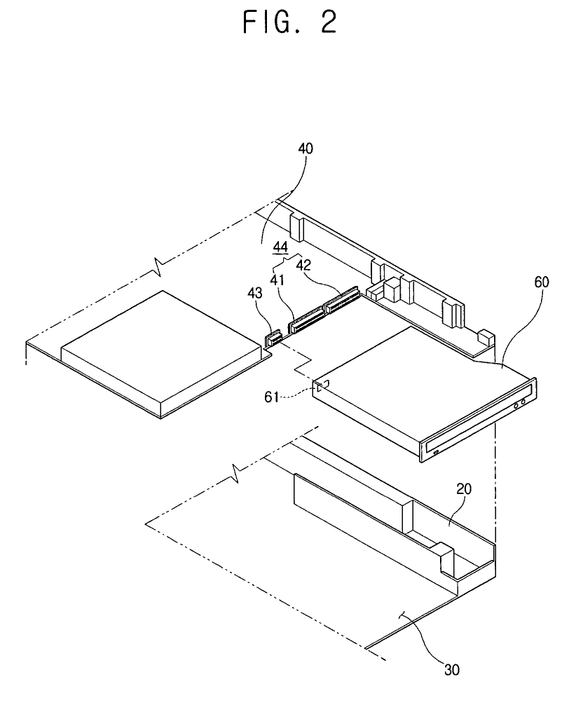

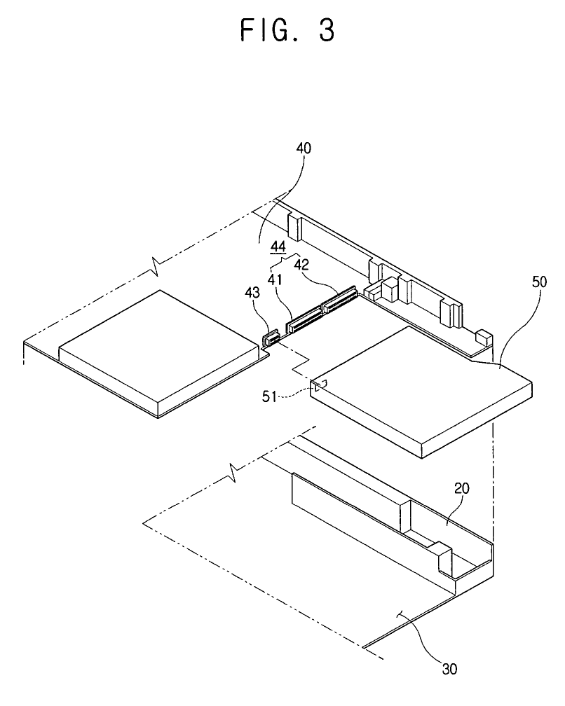

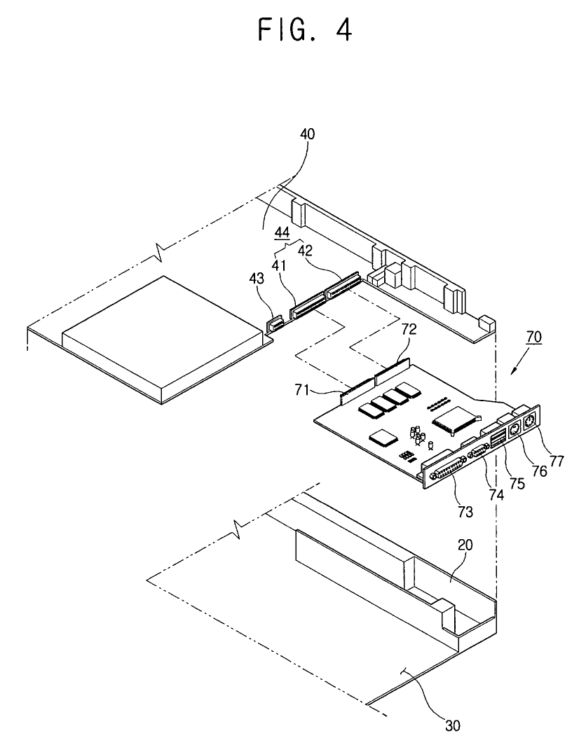

A portable computer according to an embodiment of the present invention will be described with reference to FIGS. 1 to 4. FIGS. 1 and 2 illustrate the portable computer when a CD-ROM drive 60 is employed. FIG. 3 illustrates the portable computer when a hard disk drive 50 is employed. FIG. 4 illustrates the portable computer when an extension card 70 is employed. As shown therein, the portable computer according to the shown aspect of the present invention comprises a computer main body 1; and a display part 3 which is rotatably coupled with the computer main body 1. However, it is understood that additional elements can be included in the portable computer. Moreover, it is understood that the portable computer could be a tablet PC in which the display part 3 can be combined with the keyboard 11 and/or touch pad 12 for use in data entry.

The computer main body 1 comprises an upper casing 10 and a lower casing 20 which are coupled with each other to form an accommodating space. A common mounting part 30 is provided at a lateral side of the computer main body 1 to selectively mount one of the extension card 70 and drive devices 50 and 60 therein.

A CD-ROM drive connector 61 as a drive device connector is provided in the CD-ROM drive 60 mounted in the common mounting part 30. A hard disk drive connector 51 as the drive device connector is provided in the hard disk drive 50 mounted in the common mounting part 30.

The extension card 70 is an external device which is mounted in the common mounting part 30. The extension card 70 comprises a plurality of ports which is provided at a first side thereof to be connected with a peripheral device (not shown); and a plurality of extension card connectors 71 and 72 at a second side thereof. The plurality of ports which is provided in the extension card 70 comprises a parallel port 73, a serial port 74, an USB port 75, an S-video port 76, and a PS/2 port 77, but not limited thereto. Alternatively, the number, position, and type of the ports may vary. Further, the extension card 70 can include readers, such as flash memory card readers, such as SD-card readers.

The plurality of extension card connectors 71 and 72 comprises a first extension card 71 to be connected with the parallel port 73 and the serial port 74; and a second extension card connector 72 to be connected with the USB port 75, the S-video port 76 and the PS/2 port 77.

The internal space of the common mounting part 30 has a shape to accommodate, individually, the CD-ROM drive 60, the hard disk drive 50 and the extension card 70 therein. Preferably, the CD-ROM drive 60, the hard disk drive 50 and the extension card 70 have a similar shape with each other to be accommodated in the common mounting part 30. Moreover, it is understood that the common mounting part 30 could be shaped to accommodate other devices, such as wireless cards for use in networking.

An input device such as a keyboard 11 and a touch pad 12 is provided on an upper part of the upper casing 10. Various hardware including a main board 40 having a CPU, is mounted in the internal space of the computer main body 1, that is formed by the upper casing 10 and the lower casing 20.

The main board 40 comprises an extension card mounting connector 44 with which the extension card connectors 71 and 72 of the extension card 70 are connected when the extension card 70 is mounted in the common mounting part 30. The main board 40 also includes a drive device mounting connector 43 with which the hard disk drive connector 51 or the CD-ROM drive connector 61 is connected when the hard disk drive 50 or the CD-ROM drive 60 is mounted in the common mounting part 30.

The extension card mounting connector 44 and the drive device mounting connector 43 are provided in the main board 40, and spaced from each other in a transverse direction of an insertion direction into which one of the extension card 70, the hard disk drive 50 and the CD-ROM drive 60 is inserted to the common mounting part 30. However, it is understood that these connectors 41, 44 can be otherwise arrayed.

The extension card mounting connector 44 comprises first and second extension card mounting connectors 41 and 42 which are connected with the first and second extension card connectors 71 and 72 of the extension card 70 when mounted in the common mounting part 30. While shown as to the side of the connector 43, it is understood that the connector 43 can be between connector 41, 42.

The drive device mounting connector 43 is connected with the hard disk drive connector 51 when the hard disk drive 50 is mounted in the common mounting part 30. The drive device mounting connector 43 is alternately connected with the CD-ROM drive connector 61 when the CD-ROM drive 60 is mounted in the common mounting part 30.

Hereinafter, a process of mounting one of the extension card 70, the hard disk drive 50 and the CD-ROM drive 60 in the common mounting part 30 will be described with reference to FIGS. 2 through 4. As shown in FIG. 2, to mount the CD-ROM drive 60 in the common mounting part 30, the CD-ROM drive connector 61 of the CD-ROM drive 60 is directed to the common mounting part 30. The CD-ROM drive 60 is inserted into the common mounting part 30 which is empty. When the CD-ROM drive 60 is inserted into the internal space of the common mounting part 30, the CD-ROM drive connector 61 is connected with the drive device mounting connector 43 of the main board 40 within the common mounting part 30.

As shown in FIG. 3, to mount the hard disk drive 50 in the common mounting part 30, which is empty, and the hard disk drive 50 is inserted in the common mounting part 30 which is empty after directing the hard disk drive connector 51 of the hard disk drive 50, to the common mounting part 30. When the hard disk drive 50 is inserted into the internal space of the common mounting part 30, the hard disk drive connector 51 is connected with the drive device mounting connector 43 of the main board 40 within the common mounting part 30.

As shown in FIG. 4, to mount the extension card 70 in the common mounting part 30, which is empty, the extension card 70 is inserted in the common mounting part 30 which is empty. When the extension card 70 is inserted into the internal space of the common mounting part 30, the first and second extension cards 71 and 72 of the extension card 70 are respectively connected with the first and second extension card mounting connectors 41 and 42 of the main board 40 instead of being connected with the drive device mounting connector 43 thereof.

In the portable computer according to the embodiment of the present invention shown in FIG. 1, a user may mount one of the extension card 70, and the drive device (ex. hard disk drive 50 or CD-ROM drive 60) in the common mounting part 30 without checking the position of the drive device mounting connector 43 and the extension card mounting connector 44 of the main board 40.

In a case that the plurality of ports are required to be connected with the peripheral device, the hard disk drive 50 or the CD-ROM drive 60 may be withdrawn from the common mounting part 30 and the extension card 70 having the plurality of ports may be mounted in the common mounting part 30.

The conventional portable computer employs a port replicator to provide a plurality of ports. Also, a supporting member is mounted in the computer main body of the conventional portable computer to be connected with the port replicator through the connection cable, to use the port replicator. Due to the plurality of devices such as the supporting member, the connection cable and the replicator, the conventional portable computer does not have a slim external appearance.

In the portable computer according to the embodiment of the present invention shown in FIG. 1, a user may mount the extension card 70 having the plurality of ports in the common mounting part 30 to use the plurality of ports, thereby improving user convenience and maintaining the slim external appearance of the computer main body 1.

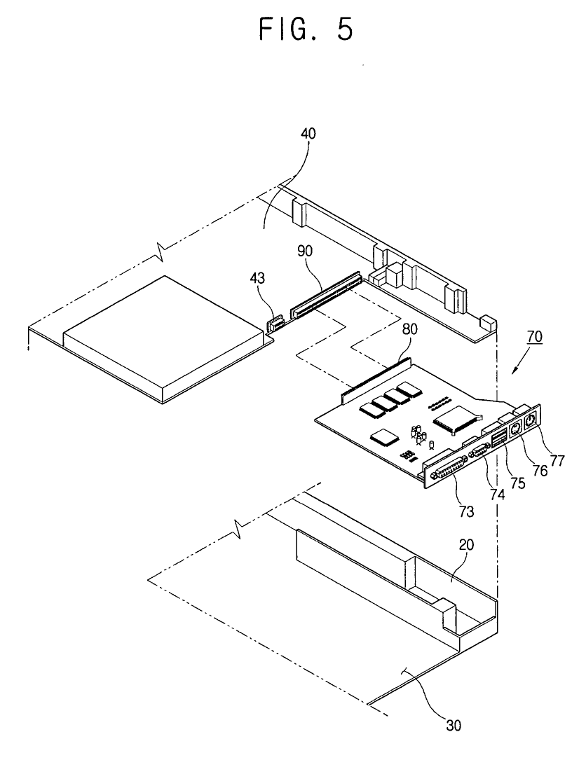

FIG. 5 illustrates a portable computer according to another embodiment of the present invention, when an extension card 70 is mounted therein. An extension card connector 80 is solely provided in the extension card 70. The extension card connector 80 is connected with the parallel port 73, the serial port 74, the USB port 75, the S-video port 76 and the PS/2 port 77.

An extension card mounting connector 90 is provided in a main board 40 corresponding to the extension card connector 80. The extension card mounting connector 90 is solely provided to correspond to the single connector 80. The connector 43 is adjacent to the connector 80.

The shape and the number of the connector and the mounting connector corresponding thereto are not limited to that in the foregoing embodiment. Alternatively, the shape and the number of the connector and the mounting connector may vary depending on hardware specification. Further, while described in the context of a portable computer, it is understood that the connection system can be implemented using non-portable computers in other aspects of the invention.

As described above, aspects of the present invention provide a portable computer in which a user easily inserts one of a plurality of external devices into a common mounting part without checking a position of a connector. Also, a user may connect a computer main body and various peripheral devices through a plurality of ports by mounting an extension card having the plurality of ports, as the external device, in the common mounting part.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A portable computer for use with a plurality of external devices having corresponding external device connectors at different positions, the portable computer comprising:
a computer main body;
a common mounting part provided at the computer main body and shaped to selectively accommodates each of the external devices; and
a plurality of mounting connectors provided at the common mounting part and disposed at different positions corresponding to positions of the corresponding external device connectors when the external devices are mounted in the common mounting part such that, when one of the external devices is mounted in the common mounting part, the corresponding external device connector connects to one of the mounting connectors, and when another of the external devices is mounted in the common mounting part, the corresponding another external device connector connects to another one of the mounting connectors.

2. The portable computer according to claim 1, wherein the plurality of mounting connectors is provided in a direction substantially perpendicular to an insertion direction of the external device.

3. The portable computer according to claim 2, wherein:
the computer main body further comprises a main board,
the one external device comprises an extension card having at least one port,
the another external device comprises a drive device,
the one mounting connector comprises an extension card mounting connector provided in the main board of the computer main body and is connected with the extension card when mounted in the common mounting part, and
the another mounting connector comprises a drive device mounting connector which is spaced apart from the extension card mounting connector and is connected with the drive device when mounted in the common mounting part.

4. The portable computer according to claim 3, wherein:
the one external device connector comprises an extension card connector provided at the extension card and, when mounted in the common mounting part, is connected with the extension card mounting connector, and
the another external device connector comprises a drive device connector which is provided in the drive device and, when mounted in the common mounting part, is connected with the drive device mounting connector.

5. The portable computer according to claim 4, wherein the drive device comprises an optical disk drive and/or a hard disk drive.

6. A portable computer for use with a first external device having a first connector and a second external device having a second connector, the portable computer comprising:
a computer main body;
a common mounting part provided in the computer main body and which is shaped to individually accommodate the first and second external devices therein; and
a first mounting connector and a second mounting connector provided in the common mounting part such that, when the first external device is mounted in the common mounting part, the first mounting connector is connected with the first connector and when the second external device is mounted in the common mounting part, the second mounting connector is connected with the second connector.

7. The portable computer according to claim 6, wherein the first and second mounting connectors are provided in a direction substantially perpendicular to an insertion direction of the first and second external devices.

8. The portable computer according to claim 6, wherein:
the first external device comprises a drive device, and
the second external device comprises an extension card which has at least one port.

9. A system for connecting a computer with a first external device having a first connector and a second external device having a second connector, the system comprising:
a common mounting part shaped to individually and non-simultaneously accommodate the first and second external devices therein;
a first mounting connector disposed at a first position of the common mounting part such that, when the first external device is mounted in the common mounting part, the first mounting connector is connected with the first connector; and
a second mounting connector disposed at a second position of the common mounting part other than the first position such that, when the second external device is mounted in the common mounting part, the second mounting connector is connected with the second connector.

10. The system according to claim 9, wherein:
the first mounting connector electrically connects a recording and/or reproducing drive to allow the computer to transfer data with respect to a recording medium in the drive, and
the second mounting connector electrically connects a card comprising a plurality of data ports to allow the computer to transfer data through the data ports.

11. The system according to claim 10, wherein the data ports comprise a parallel port, a serial port, a USB port, an S-video port, a PS/2 port, or combinations thereof.

12. The system according to claim 10, wherein the second mounting connector comprises a first port mounting connector for use with a first plurality of the ports and a second port mounting connector for use with a second plurality of ports other than the first plurality.

13. The system according to claim 10, wherein the second mounting connector comprises a common port mounting connector for use with each of the plurality of the ports.

14. The system according to claim 9, wherein:
the second mounting connector is disposed at the common mounting part such that, when the first external device is mounted, the first connector does not connect with the second mounting connector, and
the first mounting connector is disposed at the common mounting part such that, when the second external device is mounted, the second connector does not connect with the first mounting connector.

15. The system according to claim 14, wherein:
the first mounting connector electrically interconnects a recording and/or reproducing drive to allow the computer to transfer data with respect to a recording medium in the drive, and
the second mounting connector electrically connects a card comprising a plurality of data ports to allow the computer to transfer data through the data ports.

16. The system according to claim 15, further comprising a board interconnecting the first and second mounting connector and a processor of the computer.

17. The system according to claim 9, further comprising a housing of the computer, wherein the common mounting part is disposed in a bay of the housing such that the first and second external devices are mounted within an interior of the housing.

18. The system according to claim 17, wherein the housing comprises a portable computer housing having an input device and/or a display on one side of the housing, and the bay is disposed at another side of the housing adjacent to the one side.

19. A method of connecting a computer with a first external device having a first connector and a second external device having a second connector, the method comprising:
unmounting the first external device from a common mounting part shaped to individually and non-simultaneously accommodate the first and second external devices therein, where a first mounting connector is disposed at a first position of the common mounting part such that, when the first external device is mounted in the common mounting part, the first mounting connector is connected with the first connector; and
mounting the second external device in the common mounting part after the first external device is unmounted such that the second connector connects with a second mounting connector disposed at a second position of the common mounting part other than the first position.

20. The method according to claim 19, further comprising electrically connecting the first mounting connector with a recording and/or reproducing drive to allow the computer to transfer data with respect to a recording medium in the drive when the first external drive is mounted, wherein the mounting further comprises electrically connecting the second mounting connector to a card comprising a plurality of data ports to allow the computer to transfer data through the data ports.

21. The method according to claim 19, wherein:
the second mounting connector is disposed at the common mounting part such that, when the first external device is mounted, the first connector does not connect with the second mounting connector, and
the first mounting connector is disposed at the common mounting part such that, when the second external device is mounted, the second connector does not connect with the first mounting connector.

22. The method according to claim 21, further comprising electrically connecting the first mounting connector with a recording and/or reproducing drive to allow the computer to transfer data with respect to a recording medium in the drive when the first external drive is mounted, wherein the mounting further comprises electrically connecting the second mounting connector to a card comprising a plurality of data ports to allow the computer to transfer data through the data ports.

23. The method according to claim 22, wherein the computer comprises a portable computer comprising a housing, the common mounting part is disposed in a bay of the housing such that the first and second external devices are mounted within an interior of the housing.
